(19) United States
(12) Patent Application Publication
(10) Pub. No.: US 2025/0383966 A1
(43) Pub. Date: Dec. 18, 2025

(54) PROACTIVE SYSTEM CONFIGURATION BACKUP AND RESTORATION RESPONSIVE TO HARDWARE COMPONENT FAILURES

(71) Applicant: Dell Products L.P., Round Rock, TX (US)

(72) Inventors: Parminder Singh Sethi, Ludhiana (IN); Pandiyarajan Mani, Gudiyattam (IN); Banabihari Singh, Bangalore (IN)

(21) Appl. No.: 18/743,625

(22) Filed: Jun. 14, 2024

(51) Int. Cl. G06F 11/14; G06F 21/60

(52) U.S. Cl. CPC G06F 11/1446; G06F 21/602

(57) ABSTRACT

An apparatus includes at least one processing device including a processor coupled to a memory. The at least one processing device is configured to collect configuration data for a modular server including a chassis, a plurality of hardware components installed in the chassis, wherein the plurality of hardware components includes at least a first input-output module and a second input-output module, store the collected configuration data as a backup data set, determine a failure of one or more of the first input-output module and the second input-output module, and restore the configuration data for the modular server using the backup data set in response to the determined failure.

### FIELD

The field relates generally to information processing, and more particularly to managing information processing systems.

### BACKGROUND

A given set of electronic equipment configured to provide desired system functionality is often installed in a chassis. Such equipment can include, for example, various arrangements of storage devices, memory modules, processors, circuit boards, interface cards and power supplies used to implement at least a portion of a storage system, a multi-blade server system or other type of information processing system. Managing configurations of the equipment in a particular arrangement can present a significant challenge, especially in the event of a hardware component failure.

### SUMMARY

Illustrative embodiments of the present disclosure provide techniques for proactive system configuration backup and restoration responsive to hardware component failures.

In one embodiment, an apparatus includes at least one processing device including a processor coupled to a memory. The at least one processing device is configured to collect configuration data for a modular server including a chassis, a plurality of hardware components installed in the chassis, wherein the plurality of hardware components includes at least a first input-output module and a second input-output module, store the collected configuration data as a backup data set, determine a failure of one or more of the first input-output module and the second input-output module, and restore the configuration data for the modular server using the backup data set in response to the determined failure.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for proactive system configuration backup and restoration responsive to hardware component failures in an illustrative embodiment.

FIG. 2 is a flow diagram of an exemplary process for proactive system configuration backup and restoration responsive to hardware component failures in an illustrative embodiment.

FIG. 3 shows a storage architecture of a modular server in an illustrative embodiment.

FIG. 4 shows a chassis of a modular server with multiple slots in which blade and storage servers are installed in an illustrative embodiment.

FIG. 5 shows an architecture of an information processing system configured for proactive system configuration backup and restoration responsive to hardware component failures in an illustrative embodiment.

FIG. 6 shows input-output modules and expanders in an illustrative embodiment.

FIG. 7 shows an architecture for internal connections between redundant hardware components in an illustrative embodiment.

FIG. 8 shows an architecture for internal links between redundant hardware components in an illustrative embodiment.

FIG. 9 shows a proactive system configuration backup and restoration system in an illustrative embodiment.

FIG. 10 shows an expanded view of a part of a modular server chassis for the system of FIG. 9 in an illustrative embodiment.

FIG. 11 shows an expanded view of a control module for the system of FIG. 9 in an illustrative embodiment.

FIGS. 12A and 12B show exemplary workflows for a proactive system configuration backup and restoration system in an illustrative embodiment.

FIGS. 13 and 14 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

Information technology (IT) assets, also referred to herein as IT equipment, may include various compute, network and storage hardware or other electronic equipment, and are typically installed in an electronic equipment chassis. The electronic equipment chassis may form part of an equipment cabinet (e.g., a computer cabinet) or equipment rack (e.g., a computer or server rack, also referred to herein simply as a “rack”) that is installed in a data center, computer room or other facility. Equipment cabinets or racks provide or have physical electronic equipment chassis that can house multiple pieces of equipment, such as multiple computing devices (e.g., blade or compute servers, storage arrays or other types of storage servers, storage systems, network devices, etc.). As noted above, an electronic equipment chassis typically complies with established standards of height, width and depth to facilitate mounting of electronic equipment in an equipment cabinet or other type of equipment rack. For example, standard chassis heights such as 1U, 2U, 3U, 4U and so on are commonly used, where U denotes a unit height of 1.75 inches (1.75″) in accordance with the well-known EIA-310-D industry standard.

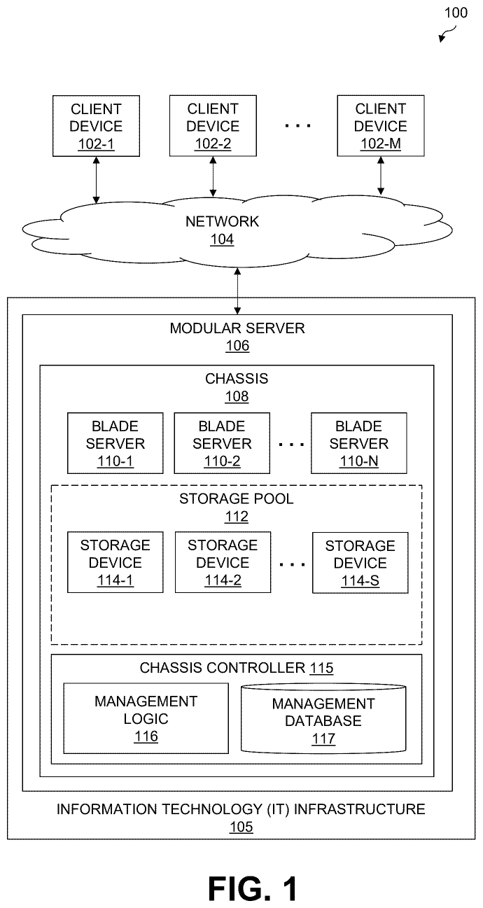

FIG. 1 shows an information processing system 100 configured in accordance with an illustrative embodiment. The information processing system 100 is assumed to be built on at least one processing platform and provides functionality for proactive system configuration backup and restoration responsive to hardware component failures. The information processing system 100 includes a set of client devices 102-1, 102-2, . . . 102-M (collectively, client devices 102) which are coupled to a network 104. Also coupled to the network 104 is an IT infrastructure 105 comprising one or more IT assets including at least one modular server 106. The IT assets of the IT infrastructure 105 may comprise physical and/or virtual computing resources. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

The modular server 106 includes a chassis 108 in which a set of blade servers 110-1, 110-2, . . . 110-N (collectively, blade servers 110) and a storage pool 112 comprising a set of storage devices 114-1, 114-2, . . . 114-S (collectively, storage devices 114) are installed. The chassis 108 also includes a chassis controller 115 implementing management logic 116 and a management database 117, which are configured to provide general management functionalities and storage of management data (e.g., blade server 110 to storage device 114 assignment, blade server 110 configuration, storage device 114 configuration, etc.) for the electronic equipment in the chassis 108.

In some embodiments, the modular server 106 is used for an enterprise system. For example, an enterprise may have various IT assets, including the modular server 106, which it operates in the IT infrastructure 105 (e.g., for running one or more software applications or other workloads of the enterprise) and which may be accessed by users of the enterprise system via the client devices 102. As used herein, the term “enterprise system” is intended to be construed broadly to include any group of systems or other computing devices. For example, the IT assets of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities). In a non-limiting example, modular server 106 may include one or more Dell MX7000 modular server chassis.

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

Although not explicitly shown in FIG. 1, one or more input-output devices such as keyboards, displays or other types of input-output devices may be used to support one or more user interfaces to the modular server 106, as well as to support communication between the modular server 106 and other related systems and devices not explicitly shown.

In some embodiments, the client devices 102 are assumed to be associated with system administrators, IT managers or other authorized personnel responsible for managing the IT assets of the IT infrastructure 105, including the modular server 106. For example, a given one of the client devices 102 may be operated by a user to access a graphical user interface (GUI) provided by the chassis controller 115 to manage one or more of the blade servers 110 and/or one or more of the storage devices 114 of the storage pool 112. In some embodiments, functionality of the chassis controller 115 (e.g., the management logic 116) may be implemented outside the chassis controller 115 (e.g., on one or more other ones of the IT assets of the IT infrastructure 105, on one or more of the client devices 102, an external server or cloud-based system, etc.).

In some embodiments, the client devices 102, the blade servers 110 and/or the storage pool 112 may implement host agents that are configured for automated transmission of information regarding the modular server 106, e.g., the current storage configuration or mapping between different ones of the storage devices 114 and particular ones of the slots of the chassis 108 in which different ones of the blade servers 110 are installed. It should be noted that a “host agent” as this term is generally used herein may comprise an automated entity, such as a software entity running on a processing device. Accordingly, a host agent need not be a human entity.

The chassis controller 115 in the FIG. 1 embodiment is assumed to be implemented using at least one processing device. Each such processing device generally comprises at least one processor and an associated memory, and implements one or more functional modules or logic for controlling certain features of the modular server 106. In the FIG. 1 embodiment, the chassis controller 115 implements the management logic 116. As mentioned, data associated with management functionalities of the management logic 116 is maintained in the management database 117. In some embodiments, one or more of the storage systems utilized to implement the management database 117 comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

It is to be appreciated that the particular arrangement of the client devices 102, the IT infrastructure 105 and the modular server 106 illustrated in the FIG. 1 embodiment is presented by way of example only, and alternative arrangements can be used in other embodiments. As discussed above, for example, the modular server 106 (or portions of components thereof, such as one or more of the management logic 116 and the management database 117) may in some embodiments be implemented internal to one or more of the client devices 102 and/or other IT assets of the IT infrastructure 105. The modular server 106 and other portions of the information processing system 100 may be part of cloud infrastructure.

The modular server 106 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the modular server 106 or components thereof (e.g., the blade servers 110, the storage pool 112, the chassis controller 115, etc.) may be implemented on respective distinct processing platforms, although numerous other arrangements are possible. For example, in some embodiments at least portions of the modular server 106 and one or more of the client devices 102 are implemented on the same processing platform. A given client device (e.g., 102-1) can therefore be implemented at least in part within at least one processing platform that implements at least a portion of the modular server 106.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, the modular server 106, the interconnect module 118 or portions or components thereof, to reside in different data centers. It is also possible in some implementations of the information processing system 500 or portions or components thereof to reside in different data centers, Numerous other distributed implementations are possible.

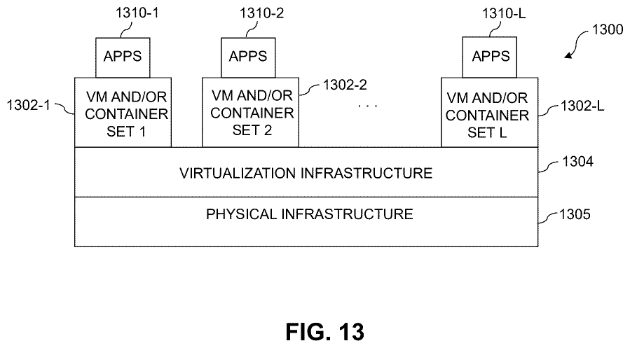

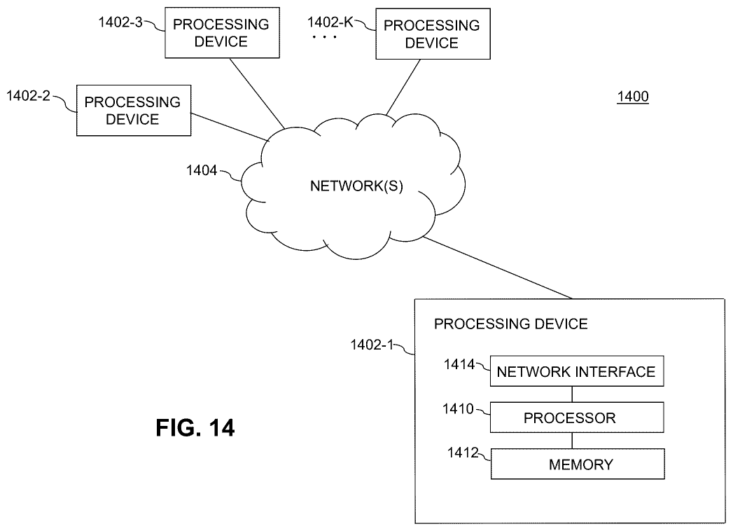

Additional examples of processing platforms utilized to implement the information processing system 100 in illustrative embodiments will be described in more detail below in conjunction with FIGS. 13 and 14.

It is to be appreciated that these and other features of illustrative embodiments are presented by way of example only, and should not be construed as limiting in any way.

It is to be understood that the particular sets of elements shown in FIG. 1 are presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

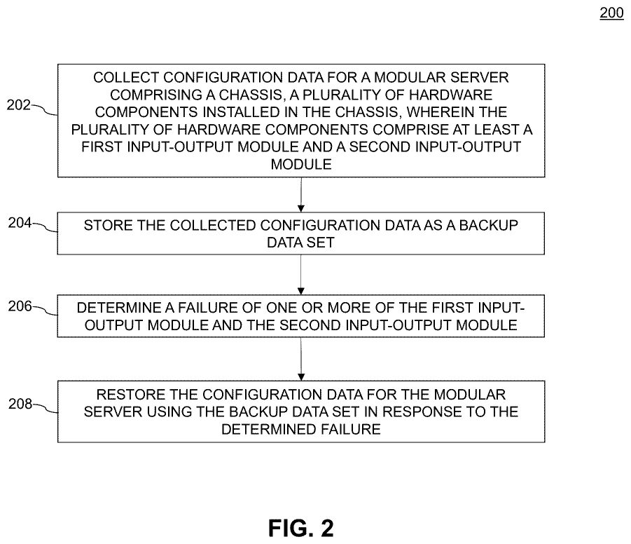

An exemplary process for proactive system configuration backup and restoration responsive to hardware component failures will now be described in more detail with reference to the flow diagram of FIG. 2. It is to be understood that this particular process is only an example, and that additional or alternative processes for proactive system configuration backup and restoration responsive to hardware component failures may be used in other embodiments.

In this embodiment, the process 200 includes steps 202 through 208. The process begins with step 202 which collects configuration data for a modular server (e.g., modular server 106) including a chassis (e.g., chassis 108), a plurality of hardware components installed in the chassis, wherein the plurality of hardware components includes at least a first input-output module (e.g., a first IOM which will be further described herein) and a second input-output module (e.g., a second IOM which will be further described herein). Step 204 stores the collected configuration data as a backup data set. Step 206 determines a failure of one or more of the first input-output module and the second input-output module. Step 208 restores the configuration data for the modular server using the backup data set in response to the determined failure.

It is realized herein that due to the hardware feasibility of accommodating a large number of hard disk drives (HDDs) or other storage devices, as well as the availability of centralized storage management functionality for multiple servers, various end-users utilize a “modular” server architecture and “blade” servers for applications which require a large amount of storage space. A modular server may include an enclosure or chassis, one or more blade servers, and one or more storage servers providing a storage pool that is utilized by the one or more blade servers. The chassis includes multiple slots in which the blade servers and storage servers may be installed. The chassis also includes management software (e.g., which may run as part of a chassis controller or chassis management console) providing various functionality for managing the blade servers and storage servers which are installed in the chassis. The chassis may also include one or more power supplies for powering the blade servers and storage servers installed in the chassis, cooling equipment (e.g., one or more fans) for cooling the blade servers and storage servers installed in the chassis, networking equipment (e.g., one or more network interface controllers, host adapters, etc.) which may be utilized by the blade servers and storage servers installed in the chassis, etc. In a modular server, the installed blade servers are physical servers configured to work independently, while the storage servers providing the storage pool may comprise a set of storage devices arranged in a Just a Bunch of Drives (JBOD) configuration.

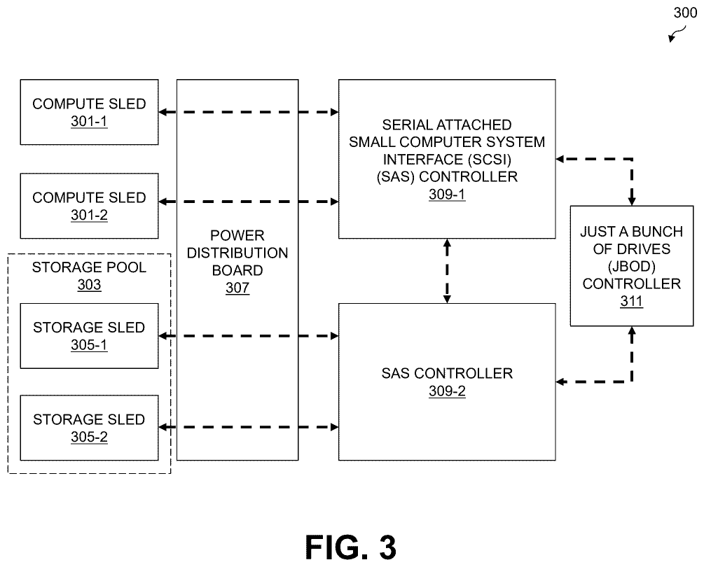

By way of example only, FIG. 3 shows a storage architecture 300 of a modular server, which includes compute sleds 301-1 and 301-2 (collectively, compute sleds 301), a storage pool 303 including storage sleds 305-1 and 305-2 (collectively, storage sleds 305), a power distribution board (PDB) 307, serial attached Small Computer System Interface (SCSI) (SAS) controllers 309-1 and 309-2 (collectively, SAS controllers 309), and a JBOD controller 311. The compute sleds 301-1 and 301-2 are each connected to each of the SAS controllers 309-1 and 309-2, via the PDB 307. Similarly, the storage sleds 305-1 and 305-2 are each connected to each of the SAS controllers 309-1 and 309-2, via the PDB 307. The SAS controllers 309-1 and 309-2 are connected to one another, as well as the JBOD controller 311. The SAS controllers 309 enable users to assign HDDs or other storage devices (e.g., of storage servers installed in the storage sleds 305 providing the storage pool 303) to different blade servers (e.g., installed in the computed sleds 301). Storage devices will be accessible only to the respective blade servers to which they are assigned. The storage devices will be accessed only by the particular blade servers assigned thereto through an internal storage controller (e.g., a Dell PowerEdge Redundant Array of Independent Disks (RAID) Controller (PERC) which is part of a corresponding one of the compute sleds 301).

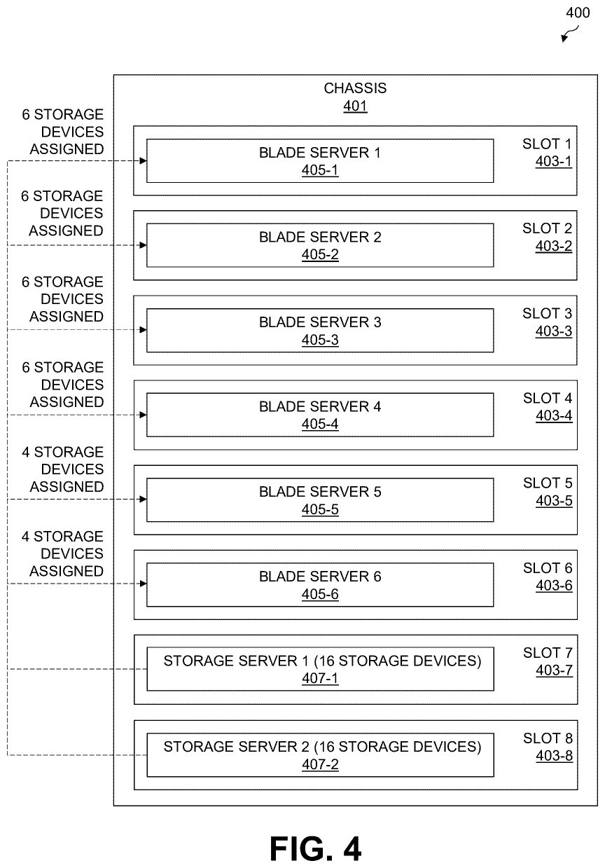

FIG. 4 shows an example of a modular server architecture 400, including a chassis 401 with a set of eight slots 403-1 through 403-8 (collectively, slots 403). A set of six blade servers 405-1 through 405-6 (collectively, blade servers 405) are installed in the slots 403-1 through 403-6 of the chassis 401, and two storage servers 407-1 and 407-2 (collectively, storage servers 407) are installed in the slots 403-7 and 403-8, respectively. The storage servers 407 may comprise Dell Insight storage pools (e.g., JBOD or other storage pools). In the FIG. 4 example, each of the storage servers 407 accommodates up to 16 HDDs or other storage devices, which are assigned to different ones of the blade servers 405 as illustrated (e.g., with six storage devices being assigned to each of the blade servers 405-1 through 405-4, and with four storage devices being assigned to the blade server 405-5 and the blade server 405-6). It should be appreciated, however, that the particular numbers of slots, blade servers, storage servers, storage devices, and the assignment of storage devices to blade servers shown in FIG. 4 is presented by way of non-limiting example only.

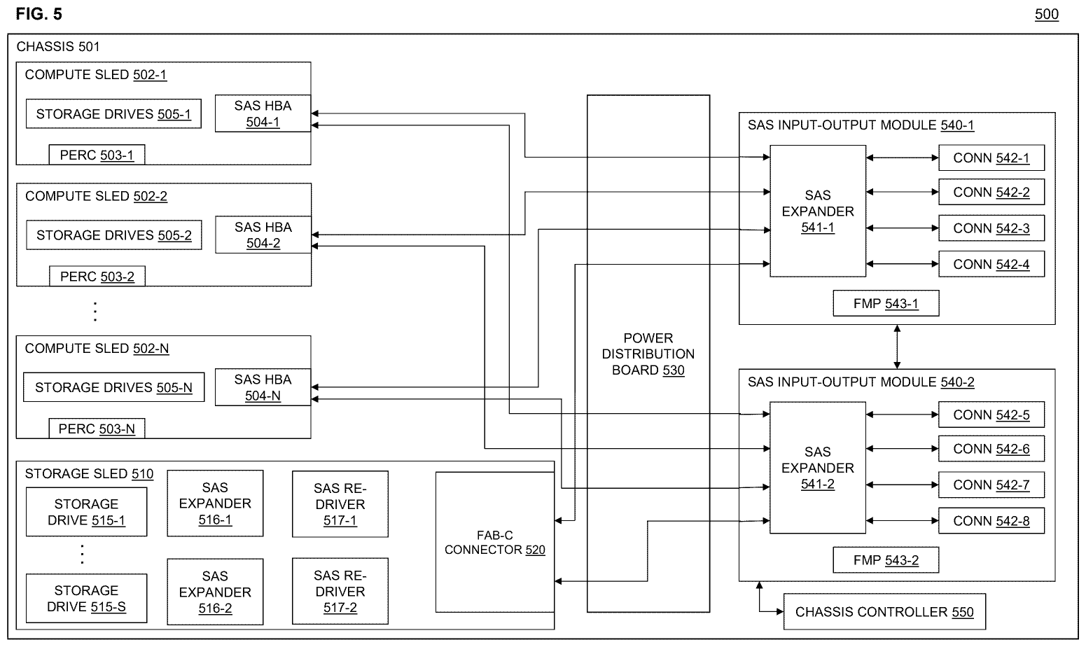

Referring to an information processing system 500 in FIG. 5 (which may be considered an example of information processing system 100 of FIG. 1), a chassis 501 includes a plurality of compute sleds 502-1, 502-2, . . . , 502-N (collectively “compute sleds 502”), and at least one storage sled 510. The compute sleds 502 respectively comprise storage drives 505-1, 505-2, . . . , 505-N (collectively “storage drives 505”), SAS host bus adaptors (HBAs) 504-1, 504-2, . . . , 504-N (collectively “SAS HBAs 504”) and PERCs 503-1, 503-2, . . . , 503-N (collectively “PERCs 503”). The storage sled 510 includes storage drives 515-1, . . . , 515-S (collectively “storage drives 515”), SAS expanders 516-1 and 516-2 (collectively “SAS expanders 516”), SAS re-drivers 517-1 and 517-2 (collectively “SAS re-drivers 517”), and a Fab-C connector 520.

The chassis 501 further includes the PDB 530, SAS IOMs 540-1 and 540-2 (“collectively “SAS IOMs 540”) and a chassis controller 550. The SAS IOMs 540-1 and 540-2 respectively comprise SAS expander 541-1 and SAS expander 541-2 (collectively “SAS expanders 541”) and fabric management processor (FMP) 543-1 and FMP 543-2 (collectively “FMPs 543”). The SAS IOM 540-1 further includes external connections (CONNs) 542-1, 542-2, 542-3 and 542-4, and the SAS IOM 540-2 further includes external connections (CONNs) 542-5, 542-6, 542-7 and 542-8. The external connections 542-1, 542-2, 542-3, 542-4, 542-5, 542-6, 542-7 and 542-8 are collectively referred to as “external connections 542.”

In illustrative embodiments, the SAS IOMs 540 and the storage sled 510 together create data paths to be used in connection with transmission and backing up of data. The SAS IOMs 540, which are examples of SAS controllers, function as managed SAS switches providing SAS attachments for end devices to associated compute servers (e.g., blade servers 110). SAS zoning is used to associate drive bays/slots within disk enclosures to the compute sleds 502. Communication from SAS IOM 540-1 to SAS IOM 540-2 and vice versa is implemented with a Gigabit Ethernet (GbE) network link, using, for example, inter-integrated circuit (I²C) protocol.

In illustrative embodiments, the storage sled 510 comprises 16 storage drives 515 such as, for example, HDDs and/or solid-state drives (SSDs). The SAS expanders 516 collectively provide dual paths to each of the storage drives 515. In some embodiments, the SAS expanders 516 are hot-swappable, meaning that they can be removed or added to the storage sled 510 while the power remains on and without shutting down or rebooting a corresponding computer or server. The storage sled 510 provides, via the SAS expanders 516 and SAS re-drivers 517 dual X4 SAS links to a next-generation modular (NGM) SAS fabric. The storage sled 510 is configured to provide 12Gb SAS support.

In illustrative embodiments, the SAS IOMs 540 support SAS 3.0 connectors capable of 12 Gb/s data transmission speeds, and are backwards compatible to 6 Gb/s speeds. Each of the SAS IOMs 540 includes eight X4 internal SAS connections for connections to compute sleds (e.g., compute sleds 502) and/or storage sleds (e.g., storage sled 510). Each of the SAS IOMs 540 further includes four X4 external SAS connections (e.g., external connections 542) for connection to external SAS JBODs. In some embodiments, each of the SAS IOMs 540 includes two X4 external SAS connectors for chassis stacking. The FMPs 543 are management processors for SAS topology and JBOD management. The chassis controller 550 may include IOM common circuits for interfacing with chassis components including, but not necessarily limited to, flexible rugged external drives (FreDs), an enclosure controller (EC) and a megaRAID storage manager (MSM).

The SAS IOMs 540 are used to provide Fabric-C SAS connectivity between compute sleds (e.g., compute sleds 502) and storage sleds (e.g., storage sled 510). The two SAS IOMs 540 are installed as a redundant pair within the chassis 501. To operate as a redundant pair the SAS IOMs 540 communicate with each other. As noted herein above, the communication is implemented with a GbE link using I²C protocol. The communication between the two SAS IOMs 540 may further include a series of general-purpose input/output (GPIO) digital signal pins routed through the PDB 530.

The SAS expanders 516 provide disk expansion for the compute sleds 502. In an illustrative embodiment, the storage drives 515 are accessed by translating a storage drawer outward and accessing the storage drives 515 from the sides of the storage drawer. In an illustrative embodiment, electrically, the storage sled 510 comprises five different types of boards, plus a cable assembly. The five boards include a Fab-C SAS interface module, a power control module, an expander module, a backplane (4x) and a front panel large expensive disk (LED) board.

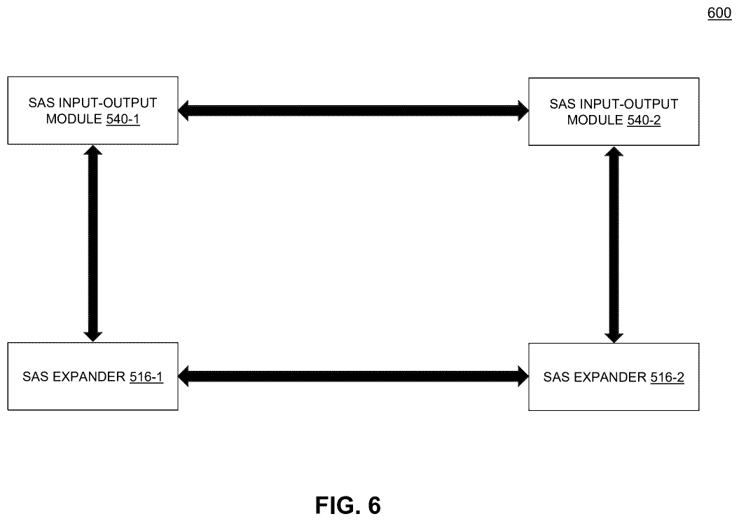

As illustrated in a simplified version of information processing system 500 of FIG. 5, an architecture 600 of FIG. 6 illustrates a first SAS IOM (e.g., 540-1) connected with a first SAS expander (e.g., 516-1) in a storage sled and vice versa, and a second SAS IOM (e.g., 540-2) connected with a second SAS expander (e.g., 516-2) in a storage sled and vice versa. The two SAS IOMs are connected to one another, while the two SAS expanders are connected to one another as well. Users may need to access run-time data from drives present in a storage sled via an SAS IOM. When users are running critical applications, SAS IOMs and/or SAS expanders in a storage sled can fail due to, for example, SAS IOM firmware updates, storage sled firmware updates, shutdowns due to power fluctuations in a datacenter and/or high system workloads. Therefore, problems exist with current approaches even if redundant hardware components fail.

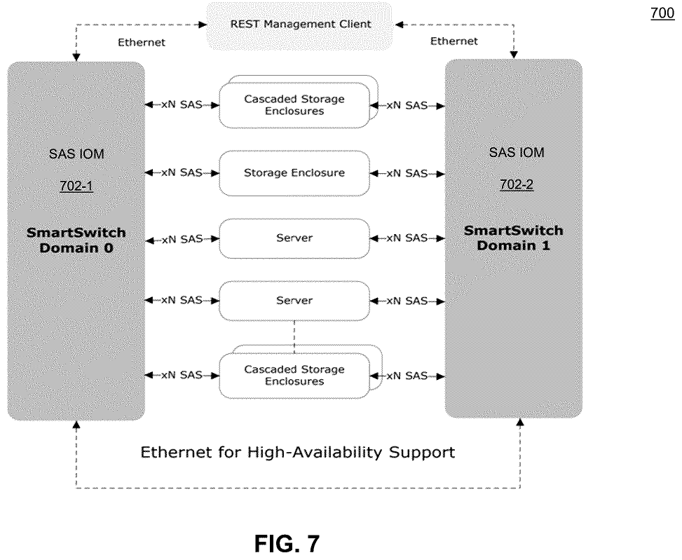

Referring now to FIG. 7, an architecture 700 illustrates internal connections between two SAS IOMs (e.g., SAS IOMs 540-1 and 540-2). As depicted in architecture 700 of FIG. 7, the first SAS IOM 702-1 is referred to as “SmartSwitch Domain 0” and the second SAS IOM 702-2 is referred to as a “SmartSwitch Domain 1.” Each of SAS IOMs 702-1 and 702-2 uses T10 SAS zoning to provide multiple SAS zones/domains for the compute sleds. SAS IOMs 702-1 and 702-2 are deployed as redundant pairs to provide multiple SAS paths to the individual storage elements or SAS disk drives. SAS IOMs 702-1 and 702-2 support GbE connections to the Fab D management fabric and private IOM to IOM communication link. The above-mentioned EC and MSM use Fab D as the communication path to manage all intelligent/managed IOMs (e.g., SAS IOMs 702-1 and 702-2). The EC or MSM provides SAS topology information to the FMP on each of SAS IOMs 702-1 and 702-2 to allow the FMP to create and manage the SAS zones.

Furthermore, virtual storage management (VSM) firmware (although not expressly shown) can be utilized in architecture 700 to manage SAS expanders within SAS IOMs 702-1 and 702-2 and any zoning-capable attached devices. The VSM firmware is a Linux-based application and is configured with various core processes that manage the following activities to provide switch platform and environmental functions: (i) SAS topology discovery; (ii) inventory and zone configuration; (iii) smart switch redundancy; (iv) event logging and health monitoring; v) switch firmware update services; and (vi) enclosure management interface. Still further, VSM firmware has an application programming interface (API) providing a REST-based interface to client software and a basic custom command line interface (CLI) with various diagnostic and configuration commands.

In some embodiments, a VSM ecosystem includes a T10 SAS zoning-compliant 12G SAS expander (smart switch expander) as its core with a management processor subsystem. The smart switch expander SAS ports can be attached to storage enclosures (e.g., JBODs) and servers (e.g., compute nodes) and provide connectivity between the servers and storage with either storage enclosure bay-based or smart switch port-based SAS zoning. In configurations with a pair of switches, e.g., architecture 700, the VSM ecosystem provides high availability and a dual domain SAS fabric. Each smart switch can be managed by the REST client using the above-mentioned REST API interface over Ethernet.

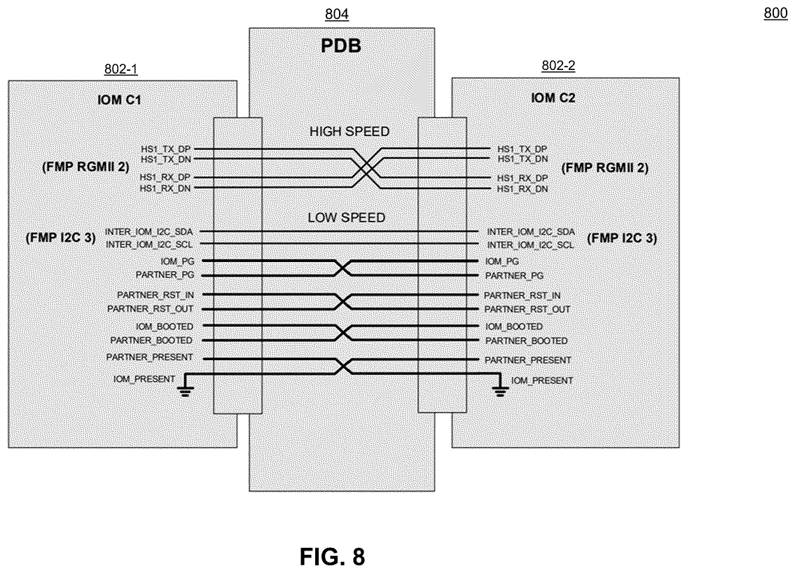

FIG. 8 illustrates an architecture 800 with internal links between two redundant SAS IOMs, i.e., SAS IOM 802-1 (IOM C1) and SAS IOM 802-2 (IOM C2), coupled by a PDB 804. Assume that SAS IOM 802-1 and SAS IOM 802-2 are used to provide Fabric C SAS connectivity between compute sleds and internal storage sleds. To operate as a redundant pair, SAS IOMs 802-1 and 802-2 need to communicate with each other. In some embodiments, the IOM-to-IOM communication is implemented with a single GbE link, an I2C link, and a series of general purpose inputs-outputs (GPIOs) routed through PDB 804.

Recall that, in a redundant SAS IOM architecture (e.g., architecture 600 of FIG. 6), a first SAS IOM (e.g., 540-1) has connections with a second SAS IOM (e.g., 540-2) and a first SAS expander (e.g., 516-1) in a first storage sled, while the second SAS IOM has connections with the first SAS IOM and a second SAS expander (e.g., 516-2) in a second storage sled. Storage assignment occurs using the above-described VSM firmware. However, in some race conditions, if redundant SAS IOMs fail, there is a high likelihood of losing storage mapping configuration information even when the failed SAS IOMs are replaced.

Illustrative embodiments overcome the above and other technical drawbacks associated with existing approaches by providing systems and methodologies for proactively system configuration backup and restoration responsive to hardware component failures.

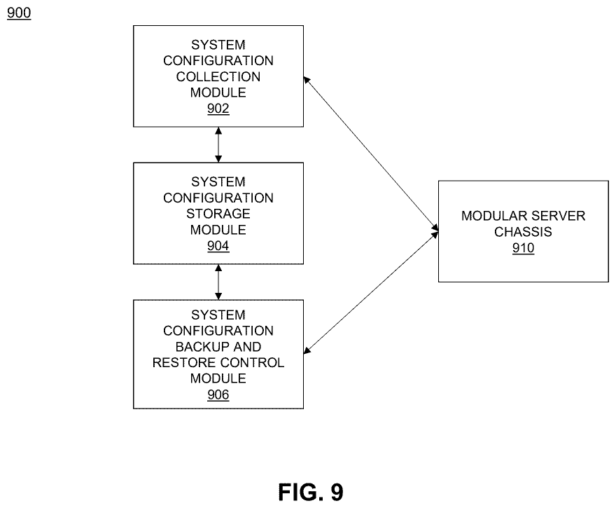

FIG. 9 illustrates a proactive system configuration backup and restoration system 900 (hereinafter system 900) according to an illustrative embodiment. As shown, system 900 comprises a system configuration collection module 902 connected to a system configuration storage module 904, and a system configuration backup and restore control module 906 connected to system configuration storage module 904. Also shown, system configuration collection module 902 and system configuration backup and restore control module 906 are connected to a modular server chassis 910 (e.g., information processing system 500 of FIG. 5).

As described above, in a modular server chassis environment, e.g., modular server chassis 910, a user can map storage drives to any compute server and use those storage drives for storing and accessing data. In some embodiments, the only way to clear the configuration would be to a factory reset of the modular server chassis. This is due to a race condition that could occur while both switches (e.g., SAS IOMs) clear their configuration. If one clears before the other one, this can lead to an active/standby condition causing a persistent zone group record sync and application of the zones to the topology. In the case where switches are configured as a redundant pair, since they are acting in active/passive roles, the user should subscribe to both switches to ensure all events are received and collated. When both redundant switches fail, in the existing design approach, there is no mechanism to recover the storage mapping configuration. Accordingly, system 900 is configured to collect storage configuration mapping information (e.g., initial configurations and changes thereto) and store (backup) the information for use in restoration. Taking a backup of the storage configuration mapping using a chassis backup and restore feature which then also restores the information when both failed SAS IOMs (i.e., hardware components) are replaced.

More particularly, a user of a modular server chassis, e.g., modular server chassis 910, is enabled to login and map storage drives to compute servers via a storage controller. In a cluster environment, one storage drive can be shared across multiple compute servers and store data for the multiple compute servers. The user can access run time data from the storage drive present in the storage sled via an SAS IOM. In the existing design approach, there is redundancy between SAS IOMs and storage servers (e.g., as shown in FIG. 6 and described above). However, if both SAS IOMs fail due for any variety of reasons (i.e., failure scenarios), there is high likelihood of losing the storage mapping configuration (e.g., which storage drives are mapped to which compute servers) even when both SAS IOMs are replaced. Accordingly, system configuration collection module 902 is configured to proactively (e.g., before the onset and/or the discovery of a hardware failure) collect such storage mapping configuration data from modular server chassis 910. In some embodiments, system configuration collection module 902 is configured to collect information including, but not limited to, storage sled information, SAS IOM health information, and current storage configuration mapping information.

System configuration storage module 904 is thus configured to store (backup) the information collected by system configuration collection module 902. In some embodiments, system configuration storage module 904 can be implemented on a restore serial peripheral interface (rSPI) module present in a chassis module of an MX7000 chassis. In such an embodiment, the rSPI module is a flash device which stores information related to the system service tag, system configurations, licenses, etc. When any changes occur in the storage configuration mapping (e.g., changes happening between storage sled and compute server assignments), such information is collected by system configuration collection module 902 and pushed to the rSPI module (i.e., system configuration storage module 904) for storage during runtime.

System configuration backup and restore control module 906 (control module 906) controls the proactive system configuration backup and restoration of the system configuration upon hardware component (e.g., redundant SAS IOMs) failures. Further, control module 906 is configured to enable the user to manage what type of information is backed up. For example, as a backup file could otherwise contain sensitive user data (e.g., passwords), the user is provided an option to include/exclude the sensitive data as part of the backup. The user is also provided with a separate option to include the Hypertext Transfer Protocol Secure (HTTPS) certificate and its private key. The contents of the backup file stored in system configuration storage module 904 (storage module 904) can be sufficiently secured (e.g., encrypted) to prevent any unwanted entity from gaining access to the file outside of the chassis. By way of example, the user can provide a pass phrase to be used along with a unique chassis encryption key to encrypt the backup file. The actual encryption can be performed by storage module 904, control module 906, or a combination thereof.

In some embodiments, the user is enabled by control module 906 to choose the backup file transport method and provide associated information as follows: (i) Network File System or NFS (address, filepath, backup file name); (ii) Common Internet Fle System or CIFS (address, filepath, backup file name, domain, username, password); and HTTPS (address, filepath, backup file name, username, password, certificate check). Further, control module 906 enables the user to provide the backup file name and the encryption password is used during the restore task for decryption. Still further, in some embodiments, the user is provided a checkbox whether to include the sensitive data in the backup. If the checkbox is unchecked, all the sensitive data will be dropped from the backup file. In some embodiments, by default, all the data will be in encrypted format using the chassis encryption key, so even if the user selected not to drop sensitive data, only hashed data will be exposed and not plain text.

During a restore task, control module 906 enables the user to select settings and configurations that can be restored. By way of example only, the user can be presented with the following options for restoration: (i) appliance settings and configurations; (ii) alert policies; (iii) catalogs and baselines; (iv) server configuration (e.g., profiles, templates, identities, virtual local area networks or VLANs); (v) storage slot mapping between storage sleds and compute servers; and (vi) storage hard drive assignment mode (i.e., enclosure assigned, drive assigned, etc.).

Once an upload task is completed, the user makes the selection of the settings that need to be restored and triggers the restore task. The restore task creates a restore job that can be tracked and monitored by the user via control module 906. The restore task compares an identifier (ID) of the intended file to be restored, sent as part of the payload, to the uploaded file ID. If the token matches, control module 906 continues with restoring the individual components. If any component fails to restore, the job denotes details of the failure. However, the restore job continues to try and restore the remaining components. The job is marked as failed if any of the components failed to restore. At the end of the flow, the uploaded file and extracted contents are deleted.

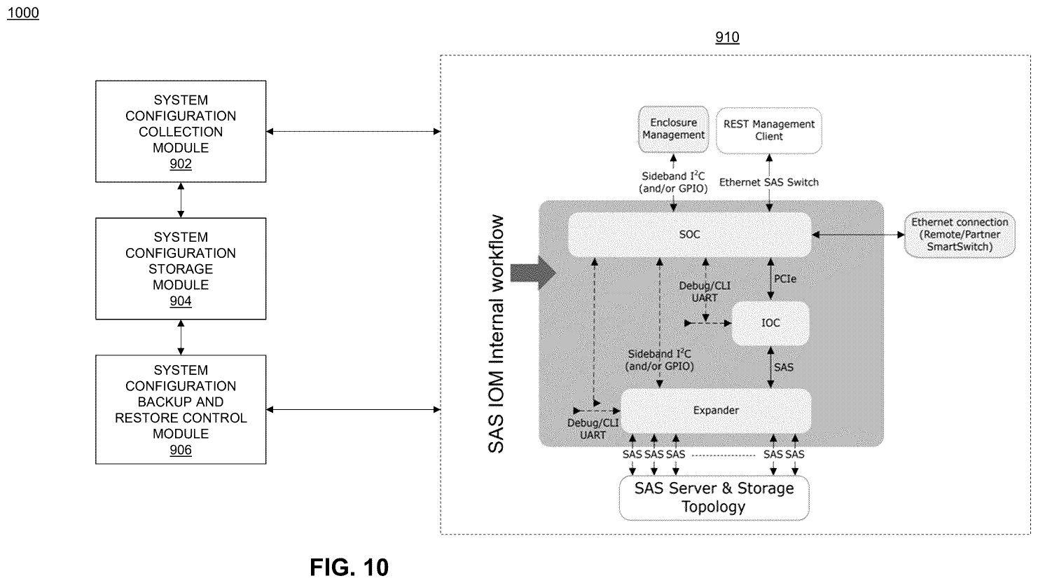

Further to the above-described functionalities of system 900, FIG. 10 illustrates an expanded view 1000 of system 900 of FIG. 9 with respect to a part of modular server chassis 910 according to an illustrative embodiment.

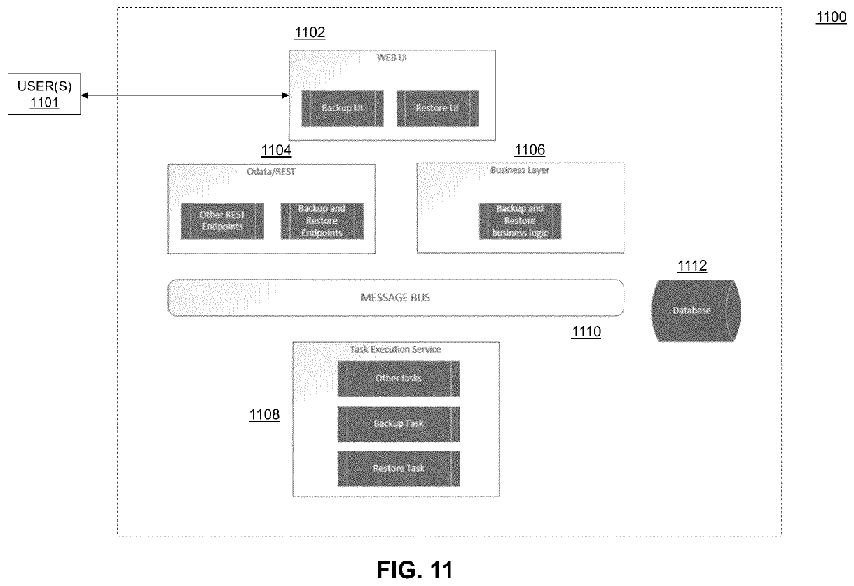

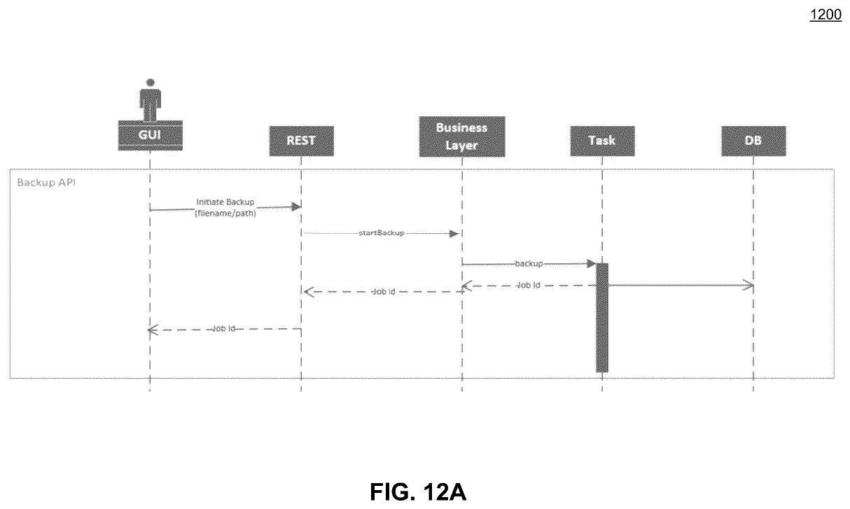

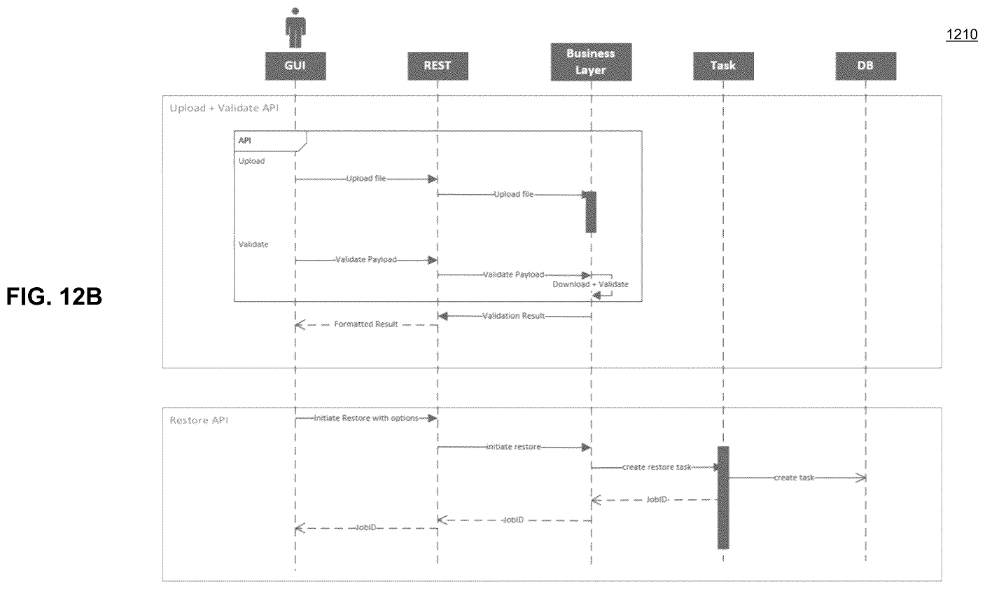

Still further to the above-described functionalities of system 900, FIG. 11 illustrates an expanded view 1100 of control module 906 according to an illustrative embodiment. As shown, one or more users 1101 access a web user interface (UI) 1102 which is configured with a backup UI and a restore UI to enable separate interfaces for the one or more users 1101 with respect to the backup task and the restore task, as described above. As further shown, control module 906 includes endpoints 1104 (e.g., data/REST interface), a business layer 1106 (e.g., business logic), and a task execution service 1108 invoked for backup, restore, and other tasks, connected via a message bus 1110. Data managed by or otherwise associated with control module 906 can be stored in a database 1112. FIGS. 12A and 12B illustrate sample workflows for a backup task 1200 and a restore task 1210, respectively, in accordance with FIG. 11.

In some embodiments, web UI 1102 is responsible for UI workflows for backup and restore tasks (operations). Endpoints 1104 are responsible for providing rest/data programmatic resource endpoints for managing the lifecycle of backup and restore tasks. Remote upload API is a task configured to upload the backup from CIFS/NFS/HTTPS share and perform validations. Business layer 1106 is responsible for core business logic that performs validations and orchestrations to successfully execute the backup or restore tasks. Database 1112 is responsible for storing results of backup and restore tasks and associated details. Backup task is a new task to take the backup of the settings and configuration, while restore task is a new task to restore the backup with the selected configurations.

Advantageously, illustrative embodiments provide an intelligent framework for collecting storage configuration data and storing the data as a backup data set in an rSPI (restore serial peripheral interface) chip module which will help the datacenter administrator (user) from rewriting/reapplying the configuration. Illustrative embodiments can take a backup with respect to the correct mapping which would be reused in terms of backup and restore which would be a savings of computing resources in the underlying computing system as well as a time savings for the datacenter administrator.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for dynamic routing of data responsive to hardware component failures will now be described in greater detail with reference to FIGS. 13 and 14. Although described in the context of the various systems described herein, these platforms may also be used to implement at least portions of other information processing systems in other embodiments.

FIG. 13 shows an example processing platform comprising cloud infrastructure 1300. The cloud infrastructure 1300 comprises a combination of physical and virtual processing resources that may be utilized to implement at least a portion of the various systems described herein. The cloud infrastructure 1300 comprises multiple virtual machines (VMs) and/or container sets 1302-1, 1302-2, . . . 1302-L implemented using virtualization infrastructure 1304. The virtualization infrastructure 1304 runs on physical infrastructure 1305, and illustratively comprises one or more hypervisors and/or operating system level virtualization infrastructure. The operating system level virtualization infrastructure illustratively comprises kernel control groups of a Linux operating system or other type of operating system.

The cloud infrastructure 1300 further comprises sets of applications 1310-1, 1310-2, . . . 1310-L running on respective ones of the VMs/container sets 1302-1, 1302-2, . . . 1302-L under the control of the virtualization infrastructure 1304. The VMs/container sets 1302 may comprise respective VMs, respective sets of one or more containers, or respective sets of one or more containers running in VMs.

In some implementations of the FIG. 13 embodiment, the VMs/container sets 1302 comprise respective VMs implemented using virtualization infrastructure 1304 that comprises at least one hypervisor. A hypervisor platform may be used to implement a hypervisor within the virtualization infrastructure 1304, where the hypervisor platform has an associated virtual infrastructure management system. The underlying physical machines may comprise one or more distributed processing platforms that include one or more storage systems.

In other implementations of the FIG. 13 embodiment, the VMs/container sets 1302 comprise respective containers implemented using virtualization infrastructure 1304 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the various systems described herein may each run on a computer, server, storage device or other processing platform element. A given such element may be viewed as an example of what is more generally referred to herein as a “processing device.” The cloud infrastructure 1300 shown in FIG. 13 may represent at least a portion of one processing platform. Another example of such a processing platform is processing platform 1400 shown in FIG. 14.

The processing platform 1400 in this embodiment comprises a portion of the various systems described herein and includes a plurality of processing devices, denoted 1402-1, 1402-2, 1402-3, . . . 1402-K, which communicate with one another over a network 1404.

The network 1404 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1402-1 in the processing platform 1400 comprises a processor 1410 coupled to a memory 1412.

The processor 1410 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1412 may comprise random access memory (RAM), read-only memory (ROM), flash memory or other types of memory, in any combination. The memory 1412 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1402-1 is network interface circuitry 1414, which is used to interface the processing device with the network 1404 and other system components, and may comprise conventional transceivers.

The other processing devices 1402 of the processing platform 1400 are assumed to be configured in a manner similar to that shown for processing device 1402-1 in the figure.

Again, the particular processing platform 1400 shown in the figure is presented by way of example only, and the various systems described herein may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for proactive system configuration backup and restoration responsive to hardware component failures as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, chassis configurations, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to collect configuration data for a modular server comprising a chassis, a plurality of hardware components installed in the chassis, wherein the plurality of hardware components comprise at least a first input-output module and a second input-output module;
to store the collected configuration data as a backup data set;
to determine a failure of one or more of the first input-output module and the second input-output module; and
to restore the configuration data for the modular server using the backup data set in response to the determined failure.

2. The apparatus of claim 1 wherein the modular server further comprises a plurality of storage devices and a plurality of compute devices, and wherein the configuration data comprises mapping data indicative of one or more assignments of one or more of the plurality of storage devices to one or more of the plurality of compute devices.

3. The apparatus of claim 2 wherein the first input-output module and the second input-output module are configured to function as redundant switches connecting at least a portion of the plurality of storage devices and at least a portion of the plurality of compute devices.

4. The apparatus of claim 1 wherein the at least one processing device is further configured to encrypt and decrypt the backup data set.

5. The apparatus of claim 4 wherein the backup data set is encrypted and decrypted using a unique chassis cryptographic key in conjunction with a data item provided by a user.

6. The apparatus of claim 1 wherein the at least one processing device is further configured to enable selective inclusion or exclusion of sensitive data from the backup data set.

7. The apparatus of claim 1 wherein the at least one processing device is further configured to update the backup data set in response to a change in the configuration data.

8. The apparatus of claim 1 wherein the at least one processing device is further configured to validate the backup data set prior to using the backup data set to restore the configuration data for the modular server.

9. The apparatus of claim 1 wherein the at least one processing device is further configured to enable selection of portions of the backup data set to be restored.

10. The apparatus of claim 1 wherein the modular server further comprises a restore serial peripheral interface module configured to store the backup data set.

11. A computer program product comprising a non-transitory processor-readable storage medium having stored therein program code of one or more software programs, wherein the program code when executed by at least one processing device causes the at least one processing device:
to collect configuration data for a modular server comprising a chassis, a plurality of hardware components installed in the chassis, wherein the plurality of hardware components comprise at least a first input-output module and a second input-output module;
to store the collected configuration data as a backup data set;
to determine a failure of one or more of the first input-output module and the second input-output module; and
to restore the configuration data for the modular server using the backup data set in response to the determined failure.

12. The computer program product of claim 11 wherein the modular server further comprises a plurality of storage devices and a plurality of compute devices, and wherein the configuration data comprises mapping data indicative of one or more assignments of one or more of the plurality of storage devices to one or more of the plurality of compute devices.

13. The computer program product of claim 12 wherein the first input-output module and the second input-output module are configured to function as redundant switches connecting at least a portion of the plurality of storage devices and at least a portion of the plurality of compute devices.

14. The computer program product of claim 11 wherein the at least one processing device is further caused to encrypt and decrypt the backup data set.

15. The computer program product of claim 11 wherein the at least one processing device is further caused to enable selective inclusion or exclusion of sensitive data from the backup data set.

16. The computer program product of claim 11 wherein the at least one processing device is further caused to update the backup data set in response to a change in the configuration data.

17. The computer program product of claim 11 wherein the at least one processing device is further caused to validate the backup data set prior to using the backup data set to restore the configuration data for the modular server.

18. The computer program product of claim 11 wherein the at least one processing device is further caused to enable selection of portions of the backup data set to be restored.

19. A method comprising:
collecting configuration data for a modular server comprising a chassis, a plurality of hardware components installed in the chassis, wherein the plurality of hardware components comprise at least a first input-output module and a second input-output module;
storing the collected configuration data as a backup data set;
determining a failure of one or more of the first input-output module and the second input-output module; and
restoring the configuration data for the modular server using the backup data set in response to the determined failure;
wherein the method is performed by at least one processing device comprising a processor coupled to a memory.

20. The method of claim 19 wherein the modular server further comprises a plurality of storage devices and a plurality of compute devices, and wherein the configuration data comprises mapping data indicative of one or more assignments of one or more of the plurality of storage devices to one or more of the plurality of compute devices.
